(19) United States
(12) Patent Application Publication
(10) Pub. No.: US 2025/0303346 A1
(43) Pub. Date: Oct. 2, 2025

(54) CARBON DIOXIDE CAPTURE DEVICE

(71) Applicant: HONDA MOTOR CO., LTD., Tokyo (JP)

(72) Inventor: Shumon HOSHINO, Saitama (JP)

(21) Appl. No.: 19/063,338

(22) Filed: Feb. 26, 2025

(30) Foreign Application Priority Data
Mar. 28, 2024 (JP) 2024-053416

(51) Int. Cl. B01D 53/04

(52) U.S. Cl. CPC B01D 53/0446; B01D 53/0438; B01D 2257/504; B01D 2258/06; B01D 2259/40088

(57) ABSTRACT

The present disclosure provides a carbon dioxide capture device capable of ventilating the inside of an exterior body without increasing energy consumption. A carbon dioxide capture device includes reactors each containing an adsorbent and performing adsorption of carbon dioxide on the adsorbent by sucking a gas containing carbon dioxide and desorption of carbon dioxide from the adsorbent by heating the adsorbent at a reduced ambient pressure; a fan that generates a gas flow in the reactors; an exterior body that houses the reactors and the fan; an adsorption line that is housed in the exterior body and connects the reactors and the fan to guide a gas discharged from the reactors during the adsorption to an outlet formed in the exterior body; and a diverter that causes part of the gas flowing through the adsorption line to flow outside the adsorption line and inside the exterior body.

This application is based on and claims the benefit of priority from Japanese Patent Application No. 2024-053416, filed on 28 Mar. 2024, the content of which is incorporated herein by reference.

### BACKGROUND OF THE INVENTION

### Field of the Invention

The present disclosure relates to a carbon dioxide capture device.

### Related Art

Techniques for capturing carbon dioxide from a carbon dioxide-containing gas such as the air have been known. For example, Japanese Unexamined Patent Application (Translation of PCT Application), Publication No. 2017-528318 describes a technique of this kind. Japanese Unexamined Patent Application (Translation of PCT Application), Publication No. 2017-528318 describes a technique of taking outside air into units to adsorb carbon dioxide on an adsorbent in the units, evacuating the units to a vacuum, and heating the units to extract carbon dioxide.

Patent Document 1: Japanese Unexamined Patent Application (Translation of PCT Application), Publication No. 2017-528318

### SUMMARY OF THE INVENTION

A carbon dioxide capture device that captures carbon dioxide as described in Japanese Unexamined Patent Application (Translation of PCT Application), Publication No. 2017-528318 includes intricately arranged components, such as multiple reactors (referred to as the units in Japanese Unexamined Patent Application (Translation of PCT Application), Publication No. 2017-528318) each having an adsorbent, a heat exchanger, a gas duct, a heating medium duct for heat exchange, and wires for various sensors. If these components are housed in a single exterior body, they can be completed into a carbon dioxide capture device in a manufacturing factory. This can guarantee required performance and allows easy transport and placement of the device, improving convenience.

The carbon dioxide capture device captures carbon dioxide at high concentration. High concentration carbon dioxide may be hazardous to the human body if it leaks to fill the inside of the exterior body, and thus the inside of the external body requires ventilation.

However, if a ventilation fan is added for the ventilation, the need arises to run the ventilation fan at any time, increasing energy consumption.

A challenge of the present disclosure is to provide a carbon dioxide capture device capable of ventilating the inside of the exterior body without increasing energy consumption.

The present disclosure addresses the challenge by the following solution. The present disclosure will be described with reference numerals corresponding to the embodiment of the present disclosure, but the disclosure is not limited to them.

A first aspect of the present disclosure is directed to a carbon dioxide capture device (1) including: a plurality of reactors (11) each having an adsorbent (12) and performing adsorption of carbon dioxide on the adsorbent (12) by sucking a gas containing carbon dioxide and desorption of carbon dioxide from the adsorbent (12) by heating the adsorbent (12) at a reduced ambient pressure; a fan (61) that generates a gas flow in the reactors (11); an exterior body (1000) that houses the reactors (11) and the fan (61); a duct (101) that is housed in the exterior body (1000) and connects the reactors (11) and the fan (61) to guide a gas discharged from the reactors (11) during the adsorption to an outlet (1020) formed in the exterior body (1000); and a diverter (1040) that causes, as a diverted gas, part of the gas flowing through the duct (101) to flow outside the duct (101) and inside the exterior body (1000).

According to a second aspect, in the carbon dioxide capture device (1) of the first aspect, the diverter (1040) generates a gas flow in the exterior body (1000) with the diverted gas.

According to a third aspect, in the carbon dioxide capture device (1) of the second aspect, the exterior body (1000) has a second outlet (1030) at a position different from the outlet (1020), and the diverter (1040) generates the gas flow toward the second outlet (1030) in the exterior (1000) body with the diverted gas.

According to a fourth aspect, in the carbon dioxide capture device (1) of the first or second aspect, the diverter (1040) is a diverter plate arranged to partially protrude into the duct (101) or a diverter pipe branched from the duct (101).

The present disclosure provides a carbon dioxide capture device capable of ventilating the inside of an exterior body without increasing energy consumption.

### BRIEF DESCRIPTION OF THE DRAWINGS

FIG. 1 is a perspective view illustrating the appearance of a carbon dioxide capture device 1 of the present embodiment;

FIG. 2 is a perspective view illustrating the appearance of the carbon dioxide capture device 1 of the present embodiment;

FIG. 3 is a sectional view of the carbon dioxide capture device 1 taken along line A-A shown in FIG. 1; and

FIG. 4 is a schematic view illustrating the configuration related to a gas flow in a reactor 11 of the carbon dioxide capture device 1 of the present embodiment.

### DETAILED DESCRIPTION OF THE INVENTION

An embodiment of the present invention will be described below with reference to the drawings.

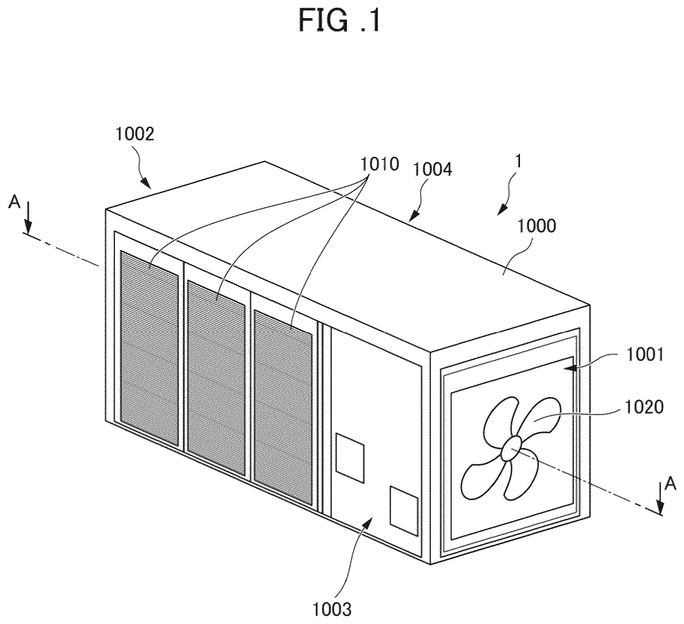

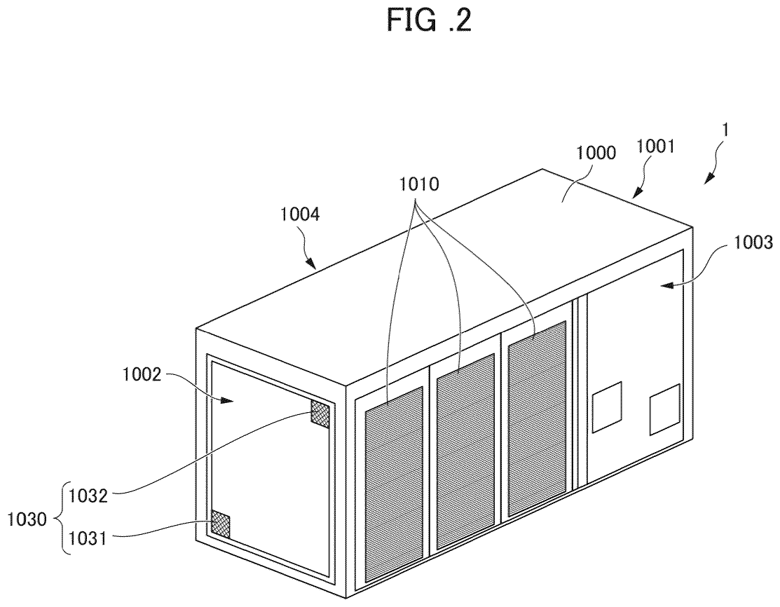

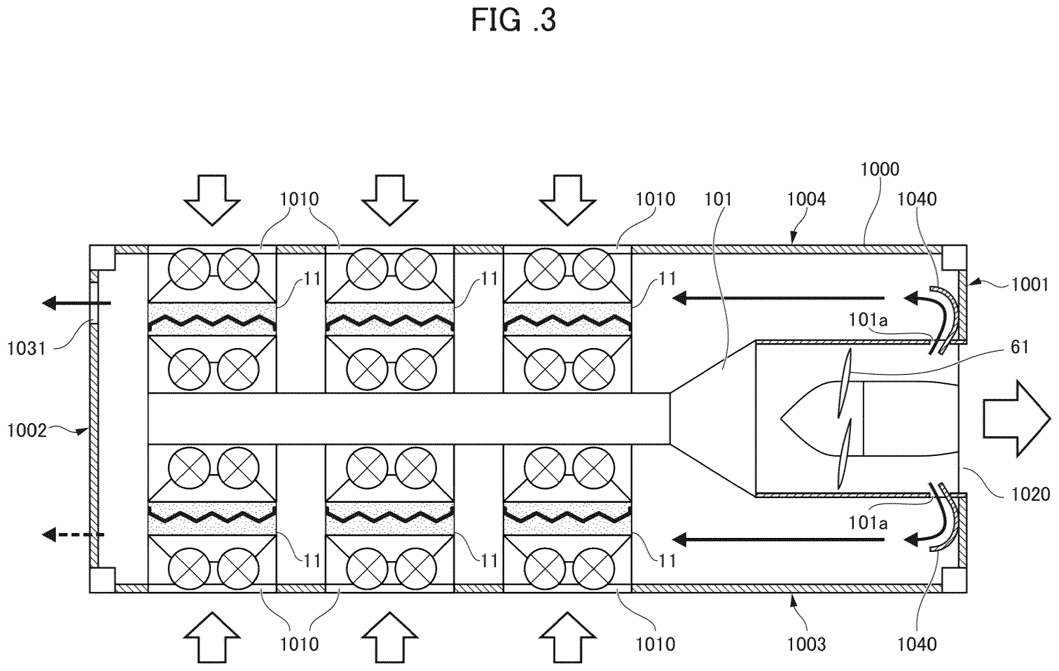

FIGS. 1 and 2 are perspective views illustrating the appearance of a carbon dioxide capture device 1 of the present embodiment. FIG. 3 is a sectional view of the carbon dioxide capture device 1 taken along line A-A shown in FIG. 1. FIG. 3 shows a cross section of a part necessary for the description, and components unnecessary for the description are omitted as appropriate. The carbon dioxide capture device 1 which is an example of a gas capture device will be described below. Note that the configuration of the present disclosure for quantity control using valves is also applicable to gas capture devices that capture other types of gas than carbon dioxide.

The carbon dioxide capture device 1 of the present embodiment is applied to, for example, direct air capture (DAC) technologies of capturing carbon dioxide in the air to lower a carbon dioxide concentration in the air. Carbon dioxide captured by the carbon dioxide capture device 1 is stored in the ground or reused as fuel or a material.

The carbon dioxide capture device 1 of the present embodiment houses main components described later, such as reactors 11, an adsorption line 101, and a fan 61, in an exterior body 1000 in a substantially rectangular parallelepiped shape. For the sake of easy description, wall surfaces of the exterior body 1000 shown in FIGS. 1 and 2 will be referred to as a front surface 1001, a rear surface 1002, a right surface 1003, and a left surface 1004. The exterior body 1000 is in the shape of a container. Thus, the carbon dioxide capture device 1 is easy to move. The shape is in accordance with the standards of shipping containers, and is convenient for maritime transport. Fork pockets provided for the exterior body 1000 allow easy transport of the exterior body 1000 to a place of installation.

The reactors 11, the adsorption line 101, and the fan 61 are arranged in the exterior body 1000. In the present embodiment, eight reactors are arranged on each of two surfaces facing in a direction substantially orthogonal to an extending direction (longitudinal direction) of a pipe as the adsorption line 101, that is, sixteen reactors 11 in total are provided. The reactors 11 have fourth valves 24 connected to the adsorption line 101 as will be described later, and are arranged in parallel to the adsorption line 101. That is, the adsorption line 101 is branched and connected to each of the reactors 11. The adsorption line 101 is a duct that connects the reactors 11 and the fan 61 to guide a gas discharged from the reactors 11 during adsorption to an outlet 1020 formed in the exterior body 1000. The arrangement of the reactors 11 relative to the adsorption line 101 shown in FIG. 3 is an example, and other arrangements are acceptable.

Each reactor 11 includes an adsorbent 12 arranged in a box-shaped housing. An end of the reactor 11 communicates with an associated one of inlets 1010 formed in the right surface 1003 and left surface 1004 of the exterior body 1000 via a third valve 23 which will be described later to suck the air into the reactor 11. The other end of the reactor 11 communicates with the adsorption line 101 via a fourth valve 24 described later.

The single fan 61 is arranged at the point where the branches of the adsorption line 101 meet. When the fan 61 is driven, a gas flow is generated, that is, the gas is taken into each of the reactors 11 arranged on the upstream side of the adsorption line 101 and then discharged from the reactors 11. This supplies the air into the reactors 11. The fan 61 discharges the air that has passed through the adsorption line 101 from the outlet 1020 formed in the front surface 1001.

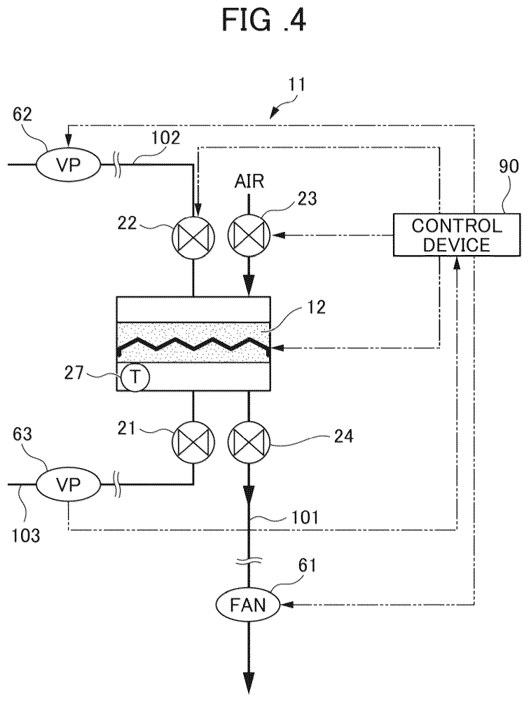

FIG. 4 is a schematic view illustrating the configuration related to the gas flow in the reactor 11 of the carbon dioxide capture device 1 of the present embodiment.

As shown in FIG. 4, the carbon dioxide capture device 1 of the present embodiment includes reactor units 10, the fan 61, a vacuum pump 62, a carbon dioxide capturing pump 63, and a control device 90.

The reactors 11 that adsorb carbon dioxide and are arranged in parallel constitute the reactor units 10. In the present embodiment, each reactor unit 10 includes a pair of right and left reactors 11, that is, 16 reactors 11 in total are arranged.

As shown in FIG. 4, each reactor 11 is a carbon dioxide capturing reactor including the adsorbent 12, a first valve 21, a second valve 22, a third valve 23, a fourth valve 24, and an adsorbent temperature sensor 27.

The adsorbent 12 is arranged in the reactor 11 to adsorb carbon dioxide. The adsorbent 12, which is a particulate material, adsorbs carbon dioxide at low temperatures (e.g., in a range of −30° C. to 50° C.) and desorbs (releases) carbon dioxide at high temperatures (e.g., in a range of 50° C. to 110° C.) and low ambient carbon dioxide concentrations. Examples of the adsorbent 12 include a carbon dioxide adsorbent such as solid amine constituted of amine supported by a porous material such as silica.

The first valve 21 is an on-off valve arranged at a junction of a carbon dioxide line 103 for capturing carbon dioxide and the reactor 11. The carbon dioxide capturing pump 63 is arranged on the carbon dioxide line 103. The second valve 22 is an on-off valve arranged at a junction of a vacuum line 102 provided with the vacuum pump 62 and the reactor 11. The third valve 23 is an on-off valve arranged at the inlet of the reactor 11 through which the air is taken into the reactor 11. The fourth valve 24 is an on-off valve arranged at a junction of the adsorption line 101 and the reactor 11. The fan 61 is arranged on the adsorption line 101.

The control device 90 controls the opening and closing of the first valve 21, the second valve 22, the third valve 23, and the fourth valve 24. The first valve 21, the second valve 22, the third valve 23, and the fourth valve 24 are constituted of, for example, butterfly valves that are normally open.

The adsorbent temperature sensor 27 measures the temperature of the adsorbent 12. Measurement information of the adsorbent temperature sensor 27 is transmitted to the control device 90.

The vacuum line 102 is branched to be connected to each of the reactors 11. The vacuum pump 62 is arranged at the point where the branches of the vacuum line 102 meet. When the vacuum pump 62 is driven, the gas in the reactors 11 is sucked through the vacuum line 102 to create a vacuum or a near vacuum inside the reactors 11.

The carbon dioxide line 103 is branched to be connected to each of the reactors 11. The carbon dioxide capturing pump 63 is arranged at the point where the branches of the carbon dioxide line 103 meet. The carbon dioxide capturing pump 63 exerts a suction force on carbon dioxide passing through the carbon dioxide line 103 and stores the captured carbon dioxide in a carbon dioxide tank (not shown).

The control device 90 will be described below. The control device 90 controls the operation of each component of the carbon dioxide capture device 1. The control device 90 controls the operation such as drive and stop of devices used to adsorb and desorb carbon dioxide. The control device 90 controls the opening and closing of the first valve 21, the second valve 22, the third valve 23, and the fourth valve 24 provided for each reactor 11. The control device 90 also controls the fan 61, the vacuum pump 62, and the carbon dioxide capturing pump 63.

The control device 90 is, for example, a computer including a central processing unit (CPU), read only memory (ROM), and random access memory (RAM). The control device 90 may be a single control device or may include two or more control devices.

### Capture of Carbon Dioxide

Control by the control device 90 for capturing carbon dioxide will be described below. The carbon dioxide capture device 1 alternately performs adsorption of carbon dioxide in the sucked gas such as the air on the adsorbent 12 in the reactor 11 and desorption of carbon dioxide adsorbed on the adsorbent 12, and compresses and stores desorbed carbon dioxide in a tank (not shown) to remove and capture carbon dioxide from the air. In the present embodiment, the adsorption and the desorption are performed in a time ratio of 7:1.

The adsorption is a step of adsorbing carbon dioxide on the adsorbent 12 in the reactor 11. For the adsorption, the third valve 23 and fourth valve 24 of the reactor 11 are open, and the first reactor 21 and the second valve 22 are closed. The fan 61 is driven to generate a gas flow from the upstream to the downstream, and the gas containing carbon dioxide (e.g., the air) is sucked through the third valve 23. The sucked gas passes through the adsorbent 12 in the reactor 11. At this time, the reactor 11 is at normal temperature (25° C.), and carbon dioxide in the gas is adsorbed on the adsorbent 12. Gases other than carbon dioxide, for example, nitrogen and oxygen, are discharged outside the carbon dioxide capture device 1 through the fourth valve 24 and the adsorption line 101.

The desorption is a step of desorbing carbon dioxide from the adsorbent 12 in the reactor 11. For the desorption, the first valve 21, third valve 23, and fourth valve 24 of the reactor 11 are closed, and the second reactor 22 is open. The vacuum pump 62 is driven to suck the gas in the reactor 11 to create a vacuum or a near vacuum in the reactor 11. At the same time, thermal energy is supplied by a heating medium flowing as a heat source through the reactor 11 to heat the adsorbent 12 in the reactor 11.

Heating the adsorbent 12 raises the temperature of the adsorbent 12 to a predetermined temperature sufficient for the desorption (e.g., 80° C.), and carbon dioxide adsorbed on the adsorbent 12 is desorbed. Then, the second valve 22, the third valve 23, and the fourth valve 24 are closed, the first valve 21 is open, and the carbon dioxide capturing pump 63 is driven to store desorbed carbon dioxide in a tank (not shown) through the carbon dioxide line 103. In the present embodiment, the adsorption and the desorption are controlled so that twelve of the sixteen reactors 11 perform the adsorption and the remaining four perform the desorption.

The carbon dioxide capture device 1 of the present embodiment configured in this manner desorbs carbon dioxide from the reactors 11 and stores desorbed carbon dioxide in a carbon dioxide tank (not shown) through the carbon dioxide line 103. Thus, high concentration carbon dioxide flows through the line from the reactors 11 in the course of the desorption to the carbon dioxide tank through the carbon dioxide line 103. High concentration carbon dioxide is harmful to human body, and it is undesirable for the exterior body 1000 to be filled with carbon dioxide even in the worst case. Thus, the carbon dioxide capture device 1 of the present embodiment includes a diverter 1040 that ventilates the inside of the exterior body 1000 during operation.

The diverter 1040 is a diverter plate which is a substantially plate-shaped member arranged downstream of the fan 61 in the adsorption line 101. The diverter 1040 has one end protruding to the inside of the adsorption line 101 and the other end located outside the adsorption line 101 and inside the exterior body 1000. The adsorption line 101 has an opening 101a in which the diverter 1040 is arranged. The diverter 1040 causes part of the gas flowing through the adsorption line 101 to flow outside the adsorption line 101 and inside the exterior body 1000. The diverter 1040 is curved so that the diverted gas flows toward the rear surface 1002.

FIG. 3 shows open arrows indicating the main gas flow generated by the fan 61 to capture carbon dioxide and solid arrows indicating the gas flow diverted by the diverter 1040. The operation of the fan 61 guides the outside air into the reactors 11 through the inlets 1010. The gas that has carbon dioxide adsorbed on the adsorbent 12 and released from the reactors 11 is discharged from the outlet 1020 through the adsorption line 101. Part of the gas pushed by the fan 61 is diverted by the diverter 1040, travels toward the rear surface 1002 from the diverter 1040, and is discharged from second outlets 1030 formed in the rear surface 1002. The gas flow from the diverter 1040 to the second outlets 1030 ventilates the exterior body 1000.

In the present embodiment, the rear surface 1002 has the second outlets 1030 including a second outlet 1031 formed in a lower part of the rear surface 1002 and a second outlet 1032 formed in an upper part of the rear surface 1002. The second outlets 1030 may be arranged in any manner and may include any number of outlets.

As described above, the carbon dioxide capture device 1 of the present embodiment is provided with the diverter 1040, allowing ventilation of the exterior body 1000 using part of the gas discharged by the fan 61 without need of any exhaust fan. Thus, the carbon dioxide capture device 1 of the present embodiment can ventilate the inside of the exterior body 1000 without increasing energy consumption.

### Variations

The present disclosure is not limited to the above- described embodiment and can be modified or altered in various ways within the scope of the present disclosure.

(1) In the embodiment, a curved plate member has been described as an example of the diverter 1040. However, the diverter may be, for example, a flat plate member. The diverter is not limited to the plate member and may be a tubular member (a diverter pipe) through which the diverted gas can pass. A member of any shape can be used as long as it can divert the gas flow from the adsorption line 101.

(2) In the embodiment, a container-shaped body has been described as an example of the exterior body 1000. However, the exterior body may be, for example, cylindrical, or may have any other shape.

Although not described in detail, the embodiment and the variations may be implemented in combination. The present disclosure is not limited to the embodiment and the variations.

### EXPLANATION OF REFERENCE NUMERALS

1 Carbon dioxide capture device
10 Reactor unit
11 Reactor
12 Adsorbent
101 Adsorption line
101a Opening
1000 Exterior body
1001 Front surface
1002 Rear surface
1003 Right surface
1004 Left surface
1010 Inlet
1020 Outlet
1030 Second Outlet
1031 Second Outlet
1032 Second Outlet
1040 Diverter

What is claimed is:

1. A carbon dioxide capture device, comprising:
a plurality of reactors each containing an adsorbent and performing adsorption of carbon dioxide on the adsorbent by sucking a gas containing carbon dioxide and desorption of carbon dioxide from the adsorbent by heating the adsorbent at a reduced ambient pressure;
a fan that generates a gas flow in the reactors;
an exterior body that houses the reactors and the fan;
a duct that is housed in the exterior body and connects the reactors and the fan to guide a gas discharged from the reactors during the adsorption to an outlet formed in the exterior body; and
a diverter that causes, as a diverted gas, part of the gas flowing through the duct to flow outside the duct and inside the exterior body.

2. The carbon dioxide capture device according to claim 1, wherein the diverter generates a gas flow in the exterior body with the diverted gas.

3. The carbon dioxide capture device according to claim 2, wherein
the exterior body has a second outlet at a position different from the outlet, and
the diverter generates the gas flow toward the second outlet in the exterior body with the diverted gas.

4. The carbon dioxide capture device according to claim 1, wherein the diverter is a diverter plate arranged to partially protrude into the duct or a diverter pipe branched from the duct.
